(19) United States
(12) Patent Application Publication
(10) Pub. No.: US 2010/0292889 A1
(43) Pub. Date: Nov. 18, 2010

(54) BRAKE OPERATION BUILT-IN TEST EQUIPMENT

(76) Inventors: Eric D. Cahill, Troy, OH (US); Dale R. Prentice, Tipp City, OH (US)

Correspondence Address: SNELL & WILMER L.L.P. (GOODRICH), ONE ARIZONA CENTER, 400 E. VAN BUREN STREET, PHOENIX, AZ, 85004-2202, US

(21) Appl. No.: 12/466,080

(22) Filed: May 14, 2009

(51) Int. Cl. G06F 19/00

(52) U.S. Cl. 701/31

(57) ABSTRACT

A system, apparatus and method provide a means for testing operation of vehicle brake system. More particularly, a brake actuator is automatically commanded to engage a brake disk stack while the vehicle is in a benign state. An engagement force applied to the brake-disk stack by the actuator then is determined, and the engagement force is compared to a first threshold value. If the engagement force is within a predetermined range of the first threshold value, it is concluded that the brake system is operating normally, otherwise it is concluded that the brake system is operating abnormally.

### FIELD OF THE INVENTION

The present invention relates generally to brakes and, more particularly, to a method, apparatus, and system for testing operation of brakes.

### BACKGROUND

Known in the prior art are aircraft wheel and brake assemblies including a non-rotatable wheel support, a wheel mounted to the wheel support for rotation, and a brake disk stack having front and rear axial ends and alternating rotor and stator disks mounted with respect to the wheel support and wheel for relative axial movement. Each rotor disk is coupled to the wheel for rotation therewith and each stator disk is coupled to the wheel support against rotation. A back plate is located at the rear end of the disk pack and a brake head is located at the front end. The brake head houses a plurality of actuator rams that extend to compress the brake disk stack against the back plate. Torque is taken out by the stator disks through a static torque tube or the like.

Operation of aircraft brake assemblies, such as the exemplary brake assembly described above, can be via a number of different methodologies. For example, hydraulic, pneumatic and electromechanical brake assemblies have been developed for various applications. To control such aircraft brake assemblies, brake control systems typically are employed wherein the brake control system receives various inputs (e.g., braking requests, configuration settings, system status, etc.) and provides outputs (e.g., brake command signals) that control application of the brakes.

An aircraft presents a unique set of operational and safety issues. For example, uncommanded braking due to failure can be catastrophic to an aircraft during takeoff. On the other hand, it is similarly necessary to have fail-proof braking available when needed (e.g., during landing).

### SUMMARY OF INVENTION

In view of the importance of braking systems, such as aircraft braking systems, it is desirable to detect any abnormality of the braking system as soon as possible and to promptly notify the flight crew and/or maintenance log. To this end, a system, apparatus and method in accordance with the present invention includes built-in test equipment (BITE) that enables an aircraft's brake system to be tested for abnormalities and/or failure during normal use of the aircraft and also prior to use of the aircraft. More particularly, a test operation is performed wherein the brakes are applied during a benign state of the aircraft (e.g., during a period when it is safe to automatically apply the brakes). During the test, the brakes are commanded to apply a level of brake force, and the applied brake force is determined (e.g., via force transducers, or inferred from data indicative of an applied force, such as position transducers or pressure transducers). The determined braking force then is compared to a range of acceptable values, and if the determined braking force is within the acceptable range, it is concluded that the brakes are operating properly. If the determined braking force is not within the acceptable range, then it is concluded that the brakes are operating abnormally. In both cases, a report of the test results can be provided to the pilot and/or logged in a maintenance log.

Further, a second test may be performed (in conjunction with the first test or independent of the first test), wherein the brakes are commanded to release all braking force, and the actual braking force applied to the brakes is determined. The determined braking force then is compared to a predetermined range (e.g., about zero) to verify that the brakes have released. If the determined braking force is within the acceptable range, it is concluded that the brakes are operating properly. If the determined braking force is not within the acceptable range, then it is concluded that the brakes are operating abnormally. This test result also can be provided to the pilot and/or logged in the maintenance log.

According to one aspect of the invention, a brake testing device and method for testing operation of an aircraft brake system includes: automatically commanding a brake actuator to apply a predetermined force to a brake-disk stack; determining an engagement force applied to the brake-disk stack; comparing the engagement force to an engagement criteria; and concluding the brake system is operating normally if the engagement force is within a predetermined range of the engagement criteria, otherwise concluding that the brake system is operating abnormally.

In one embodiment, one or more operational phases of the aircraft is/are determined, and the brake actuator is commanded to engage the brake-disk stack only when the operational phase corresponds to a predetermined operational phase. Additionally, the brake-disk stack can be commanded to release the brake-disk stack after the engagement force is determined. Then a residual force applied to the brake-disk stack is determined, and the residual force is compared to a release criteria. If the residual force is within a predetermined range of the release criteria, it is concluded that the brake system is operating normally, otherwise is concluded that the brake system is operating abnormally. The results of each comparison can be output and/or logged.

In another embodiment, an event corresponding to at least one of a brake command initiated via a brake input device, a wheel not at zero speed, or weight on the wheels is detected. If such event is detected, then the test is inhibited. Further, the test can be enabled when a landing gear handle or a gear down lock sensor transitions from a landing gear up position to a landing gear down position, and other disabling criteria are not present.

According to another embodiment, the testing device includes a first output for providing a command to the actuator, and a first input for receiving data corresponding to at least one of the engagement force and the residual force. Preferably, the logic carried out by the testing device is implemented in a hardware circuit. However, the testing device may include a processor and memory, wherein the logic is stored in memory and executed by the processor, and/or at least part of the logic is implemented in hardware and part of the logic is implemented in software. Additionally, the brake testing device may be integrated within a brake system control unit (BSCU).

According to another aspect of the invention, a brake system includes the brake testing device described herein, and a brake system control unit (BSCU) operatively coupled to the brake testing device. The system may further include an actuator and brake-disk stack, the actuator operatively coupled to the brake testing device. A force transducer may be operatively coupled to the brake testing device and to the actuator, the force transducer configured to provide data indicative of a force applied to the brake-disk stack by the actuator. Alternatively or in combination with the force transducers, one or more position transducers and/or pressure transducers may be used to infer the force applied to the brake disk stack (e.g., the force may be inferred from a position of the actuator and/or ram or from a fluid pressure provided to the actuator).

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed.

### BRIEF DESCRIPTION OF THE DRAWINGS

FIG. 1 is a schematic diagram illustrating an exemplary fluid brake system and brake system control unit (BSCU) configured to implement a brake test in accordance with the invention.

FIG. 2 is a block diagram illustrating a BSCU interfacing with a separate controller that is configured to implement a brake test in accordance with an embodiment of the invention.

FIG. 3 is a schematic diagram illustrating an exemplary electrical brake system and BSCU configured to implement a brake test in accordance with the invention.

FIG. 4 is a flowchart illustrating an exemplary brake system test in accordance with the invention.

FIG. 5 is a graphical illustration of an exemplary test of the brake system in accordance with the present invention.

### DETAILED DESCRIPTION

The principles of the invention will now be described with reference to the drawings. Because the invention was conceived and developed for use in an aircraft braking system, it will be herein described chiefly in this context. However, the principles of the invention in their broader aspects can be adapted to other types of braking systems on other types of vehicles.

A system, apparatus and method in accordance with the present invention enable vehicle brakes, such as brakes of an aircraft, to be tested during normal use of the aircraft. Results of the test can be provided to the pilot and/or logged in a maintenance log for later analysis. In accordance with the present invention, the test includes one or more of the following steps: determining an operational phase of the aircraft (e.g., moving or stationary, in flight, landing, velocity, etc.); enabling the braking system; applying and/or releasing the brakes; determining a brake force applied by the brakes; comparing the determined brake force to a window of acceptable values; and providing the results of the comparison.

Determination of the operational phase of the aircraft can be used to determine if it is safe to implement the test (e.g., is the vehicle, such as an aircraft, in a benign state wherein implementing the test will not have adverse consequences?). As will be appreciated, the test should not be implemented in certain situations, such as during take off or landing, while the pilot is depressing the brake pedal, etc. The operational phases of the aircraft can be determined from various sensor data of the aircraft. For example, in an aircraft a weight-on-wheels sensor and/or a landing gear position sensor (up or down) can be monitored to determine if the aircraft is in flight or on the ground. Other data that may be analyzed to determine the operational phase of the aircraft is wheel speed (e.g., are the wheels rotating) and/or the transition of various controls and sensors, such as a landing gear handle position or a gear downlock switch. As described in more detail below, this data is assembled and used to determine if the brake test will or will not be performed.

If the brake test is to be performed, then power, such as fluid power or electric power, is provided to a controller, such as a control valve or electro-mechanical actuator controller (EMAC). Further, the controller is commanded to provide a test braking force to the brakes. In response to the command, the controller provides power to an actuator (e.g., a pneumatic or hydraulic cylinder, or an electric motor), wherein the applied power corresponds to a test braking force.

Preferably, the test braking force corresponds to a predetermined braking force (e.g., a percentage of maximum braking force, such as 50%, 75%, etc.). However, more complex test forces may be applied by varying the force to simulate different functions of the brake system. For example, pressure may be ramped up to maximum pressure, then step to zero, step back up to maximum pressure and then ramp down to zero. By ramping the pressure, smooth operation of the system can be observed. Further, rapid drops (steps) in pressure can be used to test anti-skid operation of the system. Data corresponding to actual system response can be collected and compared to expected results stored in memory. This can include both the magnitude of brake force and system response with respect to time.

After the braking force command has been issued, a determination is made with respect to the force applied to the brake-disk stack, e.g., the magnitude of the braking force applied by the actuator. Preferably, the force applied by the brakes is determined via a transducer, such as a force transducer operatively coupled to the brakes, although other methods may be implemented (e.g., via a position transducer that provides data corresponding to a position of the actuator and/or ram, or a fluid pressure transducer that provides data corresponding to a fluid pressure provided to the actuator, each of which may be used to infer the applied force). Determination of the braking force is to include direct force measurements, as well as indirect or inferred determinations of force based on other data including, but not limited to, fluid pressure, electric current, and ram position. Once the force is determined, it is compared to an engagement criteria (e.g., a range of acceptable values, wherein the engagement criteria corresponds to the test braking force). It is noted that the engagement criteria can be single value, multiple values, or based on specific factors (e.g., the criteria may be based on a function having one or more variables). If the determined force falls within the engagement criteria, then it is concluded that the brake system is operating normally and, if it does not fall within the engagement range, then it is concluded that the brake system is operating abnormally. The results of the comparison can be output to the pilot, for example, via an annunciation panel and/or placed in a maintenance log, such as a maintenance log within a brake system control unit.

In addition to the above test, a second test can be conducted. In the second test, the controller is commanded to remove the braking force from the brakes. In response to the command, the controller removes power (fluid or electric) from the actuator, and the residual force applied to the brake-disk stack is determined (which should be at or near zero force). The residual force then is compared to a release criteria (e.g., a predetermined range at or about zero force, which may be a single value, multiple values or based on a function), and if the residual force falls within the release criteria, then it is concluded that the brake system is operating normally. If it does not fall within the second predetermined range, then it is concluded that the brake system is operating abnormally.

It is noted that the comparison of the determined brake force to the specific criteria can include both magnitude comparisons (e.g., the magnitude of the determined brake force is compared with a window of acceptable magnitudes for brake force) and timing comparisons (e.g., the magnitude of the brake force is achieved within a time period in which a normally operating brake system should have reached the same magnitude).

The brake test in accordance with the present invention can be applied periodically while the aircraft is in flight (or some other safe test period), or it can be applied as a one-shot test prior to landing. When testing during flight (i.e., not during approach to the runway), the duration of the test can be performed for any length of time, so long as the aircraft's operational phase meets the predetermined criteria for safe testing (described in more detail below). If the test is being performed prior to landing, then it is preferable that the test be performed for a preset period of time based on a particular event (e.g., transition of the landing gear from the up to down position) and then disabled.

In both cases, the duration of the test should be long enough to accurately assess operation of the brake system. In determining the test duration, the brake system's ability to deliver the volume of fluid necessary to pressurize all brakes (brake fill to contact pressure) and the time to reach stable pressure should be taken into account. In electrical brake systems, the time for the EMAC to deliver the required current, the motor's response to the current, and inertia of the motor and actuator assembly should be taken into account. Further, for electric braking systems the test can be applied to all actuators or on individual actuators.

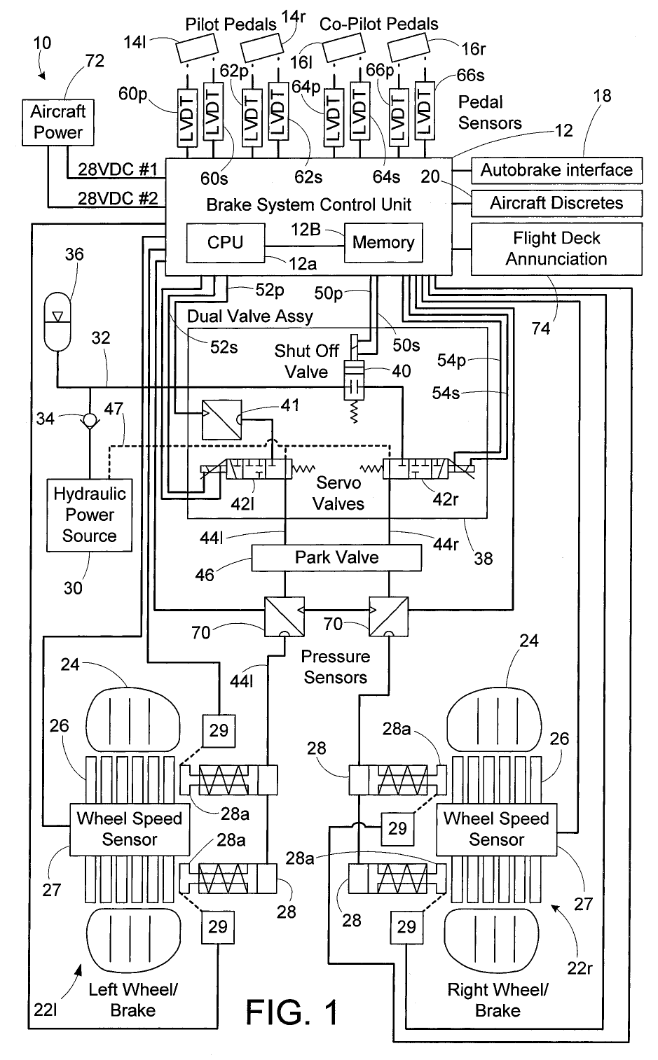

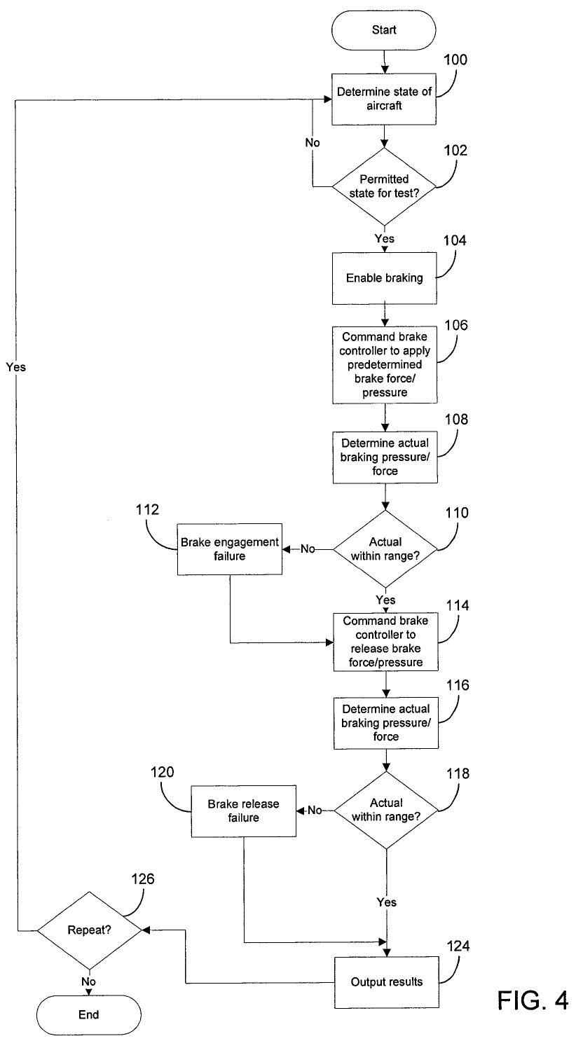

Referring now to FIG. 1, an exemplary braking system 10 is shown. The braking system 10 includes a braking system control unit (BSCU) 12, which includes a processor 12a and memory 12b (e.g., volatile and/or non-volatile memory). The memory 12b may store logic, such as program code or the like, that is executable by the processor so as to carry out conventional brake control operations as well as testing operation of a brake system. Although a micro-processor is utilized in the illustrated embodiment, processing could be done analog as opposed to digital, or intermixed with digital processing as may be desired. Additionally, at least a portion of the logic implemented by the BSCU, such as the brake test logic described herein, can be implemented via a hardware circuit in the BSCU 12, such as an ASIC or the like. Alternatively, the brake test logic may be implemented via software executed by the processor. Further details regarding the brake test logic are described below with respect to FIG. 4.

The BSCU 12 receives brake command signals from left and right pilot brake pedals 14l and 14r, respectively, and left and right co-pilot brake pedals 16l and 16r, respectively. More specifically, the BSCU 12 utilizes the outputs from the LVDT transducers 60p, 60s, 62p, 62s, 64p, 64s, 66p and 66s coupled to the respective pedals to measure the degree to which each brake pedal 14l, 14r, 16l and 16r is being depressed. The brake command signals from the pilot and co-pilot brake pedals are indicative of a desired amount of braking as is conventional. In addition, the BSCU 12 receives control signals from an autobrake interface 18 for performing conventional autobrake and rejected take-off (RTO) braking functions. The BSCU 12 also receives a series of discrete control signals associated with the aircraft, generally represented as 20, for providing conventional braking control.

In the exemplary embodiment, the BSCU 12 controls braking of a left wheel/brake assembly 22l and a right wheel/brake assembly 22r. The left wheel/brake assembly 22l includes a wheel 24 and brake stack 26, and a wheel speed sensor 27 for providing wheel speed information to the BSCU 12. A plurality of actuators 28 (also referred to as motive devices) are provided for exerting a brake force on the brake stack 26 via a reciprocating ram 28a so as to brake the wheel 24. Further, force transducers 29 corresponding to each actuator 28 measure the braking force applied by the respective actuator and communicate the measurement to the BSCU 12. The right wheel/brake assembly 22r has a similar configuration. It will be appreciated that while the present invention is described herein only with respect to two wheels, the principles of the present invention have application to any number of wheels.

A fluid power source 30, such as, for example, a hydraulic power source, serves as the main brake power supply within the system 10. A main hydraulic line 32 from the power source 30 includes a check valve 34 and accumulator 36 as is conventional. The hydraulic line 32 is input into a dual valve assembly 38 included within the system 10. The dual valve assembly 38 includes a shutoff valve 40 through which the main hydraulic line 32 supplies hydraulic fluid to the left and right wheel servo valves 42l and 42r, respectively. Pressure supplied by the shutoff valve 40 to the servo valves 42l and 42r may be measured by pressure sensor 41 and provided to the BSCU 12. Fluid from the left and right wheel servo valves 42l and 42r is provided through left and right hydraulic lines 44l and 44r, respectively, to a park valve 46 which holds the applied braking force to the wheels during a parking brake operation as is conventional. A return line 47 is provided from the servo valves 42l and 42r back to the hydraulic power source 30. During normal operation, fluid pressure through the left and right hydraulic lines 44l and 44r passes through the park valve 46 and to the corresponding actuators 28. Thus, provided the system 10 is functioning properly, the shutoff valve 40 is open during braking and the BSCU 12 controls the amount of hydraulic pressure that is delivered to each wheel 24 via the corresponding servo valve 42l and 42r.

For redundancy purposes, the BSCU 12 may include a primary control channel and a secondary control channel. I such a configuration, the shutoff valve 40 can receive a shutoff valve control signal on line 50p from the primary channel and a shutoff valve control signal on line 50s from the secondary channel. Similarly, the left wheel servo valve 42l can receive a servo valve control signal on line 52p from the primary channel and a servo valve control signal on line 52s from the secondary channel. Likewise, the right wheel servo valve 42r can receive a servo valve control signal on line 54p from the primary channel and a servo valve control signal on line 54s from the secondary channel. Because the valves in the exemplary embodiment are each dual control coil valves, each valve can be controlled by both the primary and secondary channels of the BSCU 12.

As is shown in FIG. 1, the braking system 10 includes pressure sensors 70 for monitoring the hydraulic pressure in lines 44l and 44r and providing such information back to the BSCU 12. In addition, power to the BSCU 12 preferably is provided via two separate and independent power buses designated 72. The braking system 10 further includes a cockpit display 74 coupled to the BSCU 12. The display 74 communicates to the pilot and co-pilot information relating to the braking operations as is conventional, and further alerts the pilot and co-pilot of the brake test results as discussed below.

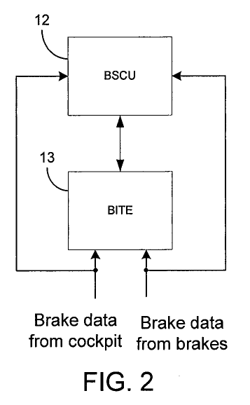

Although FIG. 1 illustrates a BSCU for implementing the brake system test logic described herein, the brake system test logic may be implemented in a separate controller that interfaces with the BSCU. FIG. 2 is a simple schematic diagram illustrating the relationship between the BSCU 12 and BITE controller 13 in such a configuration. As can be seen in FIG. 2, both the BSCU 12 and a separate BITE controller 13 receive brake command data (e.g., data input by the pilot, such as brake pedal position, brake settings, etc.) and system data (e.g., data from the force transducers, pressure sensors, wheel speed sensors, weight-on-wheels sensors, landing gear position sensors, etc.). Further, the BSCU 12 and the BITE controller 13 are configured to communicate data to one another, such as results of the test, for example. Preferably, the BITE controller 13 implements the brake system test logic in a hardware circuit, such as an ASIC or the like, but also may be configured to implement the logic via software, or implement part of the logic in hardware and part of the logic in software. Although the BITE controller 13 is separate from the BSCU 12, overall operation of the brake system test logic is substantially the same as the embodiment of FIG. 1.

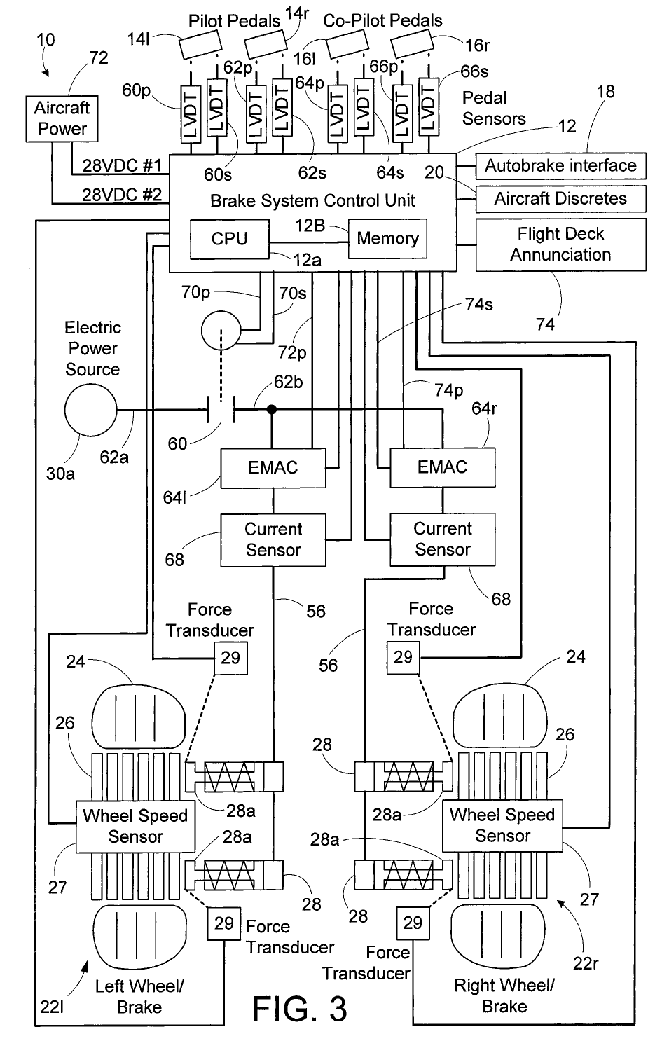

Moving now to FIG. 3, there is shown another embodiment of a brake system that can be used with the method, apparatus and system according to the present invention. The brake system 10′ shown in FIG. 3 is an electrical brake system as opposed to a fluid brake system shown in FIG. 1. As is evident, many of the components in FIGS. 1 and 3 are the same. Therefore, only those components that are different between the two exemplary systems will be described.

The system shown in FIG. 3 includes an electric power source 30a, such as an alternator, which serves as the main brake power supply within the system 10′. One side of a contactor 60 is electrically coupled to the electric power source 30a via conductors 62a. The other side of the contactor 60 is electrically coupled to left and right electromechanical actuator controllers (EMACs) 64l and 64r via conductors 62b, each of which are operative to control actuators 28 (electric motors in the embodiment of FIG. 3) on respective left and right wheels. The contactor 60 is functionally analogous to the shut off valve in the fluid system and operates to couple or remove electrical power from the braking system.

The EMACs 64l and 64r are electrically coupled to respective actuators 28 via conductors 66, and are operative to provide electrical current thereto so as to effect a braking force on the respective brake-disk stack 26. Current provided to the actuators 28 is measured by current sensors 68, and the measured current is provided back to the BSCU 12.

As noted above, the BSCU 12 may include a primary control channel and a secondary control channel. In such configuration, the contactor 60 can receive a control signal on line 70p from the primary channel and a control signal on line 70s from the secondary channel. Similarly, the left wheel EMAC 64l can receive an EMAC control signal on line 72p from the primary channel and an EMAC control signal on line 72s from the secondary channel, and the right wheel EMAC 64r can receive an EMAC control signal on line 74p from the primary channel and an EMAC control signal on line 74s from the secondary channel. The respective EMACs 64l and 64r are each configured to be controlled by both the primary and secondary channels of the BSCU 12.

In operation, the BSCU 12 controls the application of power to the EMACs 64 via contactor 60 via primary and secondary channels 70p and 70s. Further, the BSCU 12, via the primary and secondary channels 72p, 72s, 74p, 74s, provides instructions to the respective EMACs regarding when to apply the brakes and the brake force to be applied by the brakes. This operation of the respective devices by the BSCU 12 includes executing brake test logic as described herein.

With additional reference to FIG. 4, illustrated are logical operations to implement an exemplary method for testing operation of a vehicle brake system in accordance with the present invention. The flow chart of FIG. 4 may be thought of as depicting steps of a method carried out by the BSCU 12 or a separate controller. Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Beginning with block 100, a determination is made regarding the operational phase of the aircraft. The operational phase of the aircraft is used to determine if it is permissible to test the brake system. As will be appreciated, the specific circumstances for enabling or disabling the test may be specific to the type of aircraft, its cargo, etc. Several examples of data that can be used to determine the operational phase of the aircraft are provided below.

As noted above, testing of the brake system is performed while the aircraft is in a benign state, i.e., while the aircraft is in a state that is safe to test the brakes. Preferably, testing of the brakes is performed while the aircraft is in flight, although the test also may be implemented while the aircraft is on the ground (e.g., while parked or other benign state). When implementing the test during flight, the test may be performed periodically, or just prior to landing. The criteria for determining if it is permissible to conduct the test can be based on data from various sensors and switches of the aircraft.

For example, when in flight, the test should not be conducted when any of the brake pedals are being applied, when any of the wheels are rotating, or when weight is detected on the wheels (this indicates another problem, as there should not be weight on the wheels during flight). Application of the brake pedals can be determined from data provided by sensors coupled to the brake pedals (e.g., from the LVDT sensors 60-66, for example). Wheel speed can be determined from data provided by wheel speed sensors 27, while weight on the wheels can be determined from a weight-on-wheels sensor (not shown). If the pedals are not being applied, the wheels are not rotating, and there is no weight on the wheels, then this can be considered a benign state in which to the test can be conducted.

If the test is to be performed just prior to landing, then the criteria may be somewhat different. For example, the test may be initiated when the landing gear handle (i.e., the handle for moving the landing gear up or down) or the gear downlock sensor (i.e., the sensor that confirms the landing gear are in the down and locked position) indicate a transition from up to down. When performing the test just prior to landing, it is preferable that the test be a one-shot test (i.e., it is performed only once).

Although not preferred, the test may be performed while on the ground. In this instance, the test may be performed when none of the pedals are being applied, and none of the wheels are rotating, and the throttle is below a predetermined setting. Other criteria also may be used to ensure the aircraft is in a state that is safe for performing the test.

Moving to block 102, if the operational phase does not correspond to a benign state, then the test is not performed, and the method loops at block 100. However, if the operational phase does correspond to a benign state, then at block 104 the braking system is enabled. In a hydraulic brake system, the system can be enabled, for example, by turning on (e.g., opening) the shut-off valve 40, thereby providing fluid power to the servo valves 42l and 42r. In an electrical braking system, enabling the system may comprise closing the contactor 60, for example, so as to provide electrical power to the EMACs 64l and 64r.

Once the brake system is enabled, the servo valves 42l and 42r (or EMACs (64l and 64r) are commanded to provide a braking force to the brake-disk stack 26 as indicated at block 106. The applied braking force preferably is a preset braking force that can be based on a percentage of maximum braking force (e.g., the applied braking force may be 75% of maximum braking force). In response to the commanded braking force, the servo valves provide fluid power to the actuators 28 (or the EMACs provide electric current to the actuators 28), and the actuators apply a force on the brake-disk stack 26. At block 108, the braking force applied to the brake-disk stack is determined, for example, via force transducer 29, inferred from pressure sensors 70 (for fluid powered systems), electric current as measured by current sensors 68 (for electric powered systems), a position of the ram 28a a determined from position sensors (not shown), etc. The measured parameter (e.g., force, pressure, current, etc.) corresponding to braking force can be input into an analog hold circuit or can be latched in an analog-to-digital converter so as to retain the sampled value. Preferably, the data corresponding to the braking force is captured when steady state braking force should be achieved on all properly operating brakes (e.g., within a predetermined time period after issuing the command to apply the test brake force). This time period, for example, can be determined empirically on a brake system that is operating normally.

At block 110, the determined braking force is compared to engagement criteria. For example, a window comparator can be implemented in analog or digital circuitry. If implemented digitally, then a simple digital comparison can be performed, wherein the upper order bits of the measured value are compared to a preset bit pattern representative of the acceptable braking force, and the least significant bits are “don't care” bits. For example, a measurement represented digitally as 0011 1100 1110 (from MSB to LSB) is acceptable if the higher level bits match 0011 110X XXXX (where X denotes don't care).

At block 110, if the braking force is not within acceptable range (e.g., the high-order bits do not match or the analog value is not within the acceptable window), then the brake system has a brake engagement failure, as indicated at block 112. However, if the braking force is within acceptable range (e.g., the high-order bits match or the analog value is within the acceptable window), then brake engagement is operating normally and at block 114 a second test is performed. More particularly, the servo valves 42l and 42r (or EMACs 64l and 64r) are commanded to release the braking force applied to the brake-disk stack 26. In response thereto, the servo valves 42l and 42r and/or the shut of valve 40 cut off fluid power to the actuators 28 (or the EMACs 64l and 64r and/or contactor 60 interrupt the flow of electric current to the actuators 28), and the actuators 28 release the brake-disk stack 26. At block 116, a predetermined time after the command to release the braking force has been issued, the residual force applied to the brake-disk stack is determined as described above.

At block 118, the residual braking force is compared to release criteria. In this portion of the test, exemplary acceptable values may correspond to zero or near zero braking force. If the braking force is not within acceptable range, then the brake system has a brake release failure, as indicated at block 120. However, if the braking force is within acceptable range, then the brake release function is operating normally.

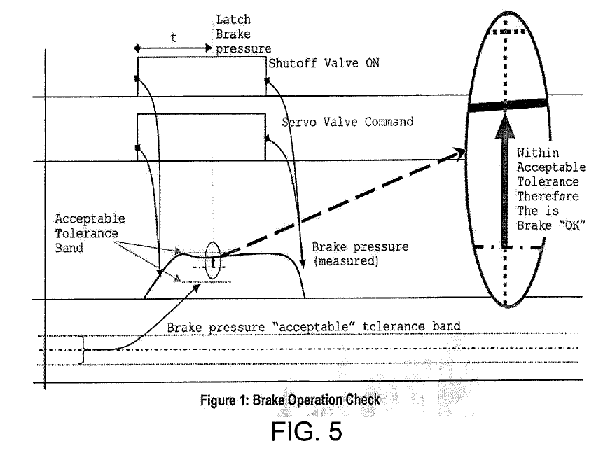

FIG. 5 graphically illustrates an exemplary sequence of events that may occur during the test for hydraulically operated brakes. At time to the shut off valve 40 is turned on so as to provide fluid power to the servo valves 42l and 42r. At about the same time to, the servo valves 42l and 42r are commanded to open so as to provide fluid power to the actuator 28, wherein the fluid power provided to the actuator 28 corresponds to a predetermined braking force. Shortly after time to, the brake pressure applied to the brake-disk stack 26 ramps up and then settles. Within a predetermined time period after the brake command has been issued, the brake pressure provided to the actuators 28 is determined and compared to a high and low range (e.g., the acceptable tolerance band). Based on the comparison, it is concluded that the brakes are or are not operating properly.

Moving back to FIG. 4, at block 124 the results of the test are output to the flight deck annunciator 74 and/or provided within a maintenance log. Such maintenance log may reside within the BSCU 12, for example, or within the BITE controller 13. At block 126, it is determined if the test is to repeat (e.g., is the test an in-flight test or a test just prior to landing?) and if so, the method loops back to block 100 and repeats. Otherwise, the test ends.

In determining if a problem exists with the brake system, there may be several levels of fault detection, acceptability in brake performance, and fault annunciation. For example, a fault may be considered as a subtle loss in performance (e.g., response time was longer than typical), although the system still is functional, or a total loss of braking capability (e.g., no braking force was measured or the brakes failed to release). Other considerations may include how many brakes have failed the test, or how many actuators failed the test.

Accordingly, a brake controller, system, and method are provided that can automatically test operation of the brake system during use of the aircraft. The brake test described herein can provide advance warning of impending brake issues that can be immediately addressed when the aircraft touches own.

A person having ordinary skill in the art of computer programming and applications of programming for computer systems would be able in view of the description provided herein to program the BSCU and/or BITE controller to operate and to carry out the functions described herein. Accordingly, details as to the specific programming code have been omitted for the sake of brevity. Also, while software in the memory or in some other memory of the BSCU or BITE controller may be used to allow the system to carry out the functions and features described herein in accordance with the preferred embodiment of the invention, such functions and features also could be carried out via dedicated hardware, firmware, software, or combinations thereof, without departing from the scope of the invention.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A brake testing device for testing operation of a vehicle brake system, said brake testing device comprising logic configured to:
automatically command a brake actuator to apply a predetermined force to a brake-disk stack;
determine an engagement force applied to the brake-disk stack;
compare the engagement force to engagement criteria; and
conclude the brake system is operating normally if the engagement force is within a predetermined range of the engagement criteria, otherwise conclude that the brake system is operating abnormally.

2. The brake testing device according to claim 1, wherein the logic is further configured to:
determine an operational phase of the vehicle; and
command the brake actuator to engage the brake-disk stack only when the operational phase corresponds to a predetermined operational phase.

3. The brake testing device according to claim 1, wherein the logic is further configured to:
command the actuator to release the brake-disk stack after the engagement force is determined;
determine a residual force applied to the brake-disk stack after the actuator has been commanded to release the brake-disk stack;
compare the residual force to a release criteria; and
conclude the brake system is operating normally if the residual force is within a predetermined range of the release criteria, otherwise conclude that the brake system is operating abnormally.

4. The brake testing device according to claim 1, wherein the logic is further configured to output the results of each comparison.

5. The brake testing device according to claim 1, wherein the logic that determines the engagement force applied to the brake-disk stack includes logic configured to measure the force applied to the brake-disk stack.

6. The brake testing device according to claim 1, wherein the logic is further configured to:
detect an event corresponding to at least one of a brake command initiated via a brake input device, a wheel not at zero speed, or weight on the wheels; and
inhibit testing when the event is detected.

7. The brake testing device according to claim 1, wherein the logic is further configured to enable testing when a landing gear handle or a gear down lock sensor transitions from a landing gear up position to a landing gear down position.

8. The brake testing device according to claim 1, further comprising:
a first output for providing a command to the actuator; and
a first input for receiving data corresponding to at least one of the engagement force and the residual force.

9. The brake testing device according to claim 1, wherein the logic is implemented in a hardware circuit.

10. The brake testing device according to claim 1, further comprising a processor and memory, wherein the logic is stored in memory and executable by the processor.

11. The brake testing device according to claim 1, wherein the brake testing device is integrated within a brake system control unit (BSCU).

12. A brake system, comprising:
the brake testing device according to claim 1; and
a brake system control unit (BSCU) operatively coupled to the brake testing device.

13. The brake system according to claim 12, further comprising the actuator and brake-disk stack, the actuator operatively coupled to the brake testing device.

14. The brake system according to claim 12, further comprising at least one of a force transducer, position transducer, or pressure transducer operatively coupled to the brake testing device and to the actuator, said at least one transducer configured to provide data indicative of a force applied to the brake-disk stack by the actuator, a position of the actuator, or fluid pressure provided to the actuator.

15. A method for testing operation of vehicle brake system, said brake system including an actuator for selectively engaging a brake-disk stack so as to apply and release braking force on a rotatable member, the method comprising:
automatically commanding the actuator to apply a predetermined force to the brake disk stack;
determining an engagement force applied to the brake-disk stack;
comparing the engagement force to an engagement criteria; and
concluding the brake system is operating normally if the engagement force is within a predetermined range of the engagement criteria, otherwise concluding that the brake system is operating abnormally.

16. The method according to claim 15, wherein automatically commanding the actuator includes
determining an operational phase of the vehicle; and
commanding the actuator only when the operational phase corresponds to a predetermined operational phase.

17. The method according to claim 15, further comprising:
commanding the actuator to release the brake disk stack after the engagement force is determined;
determining a residual force applied to the brake-disk stack after the actuator has been commanded to release the brake-disk stack;
comparing the residual force to a release criteria; and
concluding the brake system is operating normally if the residual force is within a predetermined range of the release criteria, otherwise concluding that the brake system is operating abnormally.

18. The method according to claim 15, wherein determining at least one of the engagement force or the residual force includes at least one of
using a force transducer to measure the respective force applied to the brake-disk stack,
using a position transducer infer the respective force applied to the brake disk stack from a position of force transducer to measure the respective force applied to the brake-disk stack from a position of the actuator, or
using a pressure transducer to infer the respective force applied to the brake disk stack from a fluid pressure provided to the actuator.

19. The method according to claim 15, further comprising inhibiting the test when at least one of a brake command is initiated via a brake input device, a wheel is not at zero speed, or weight on the wheels is detected.

20. The method according to claim 15, further comprising enabling the test when a landing gear handle or a gear down lock sensor indicates a transition from the landing gear being in the up position to the landing gear being in the down position.
